(19) United States
(12) Patent Application Publication
(10) Pub. No.: US 2025/0135509 A1
(43) Pub. Date: May 1, 2025

(54) Portable Liquid-Delivery System

(71) Applicant: Rack Wash LLC, Victor, NY (US)

(72) Inventors: Joseph A. Talarico, Victor, NY (US); Brett Beachner, Victor, NY (US)

(21) Appl. No.: 18/925,006

(22) Filed: Oct. 23, 2024

Related U.S. Application Data
(60) Provisional application No. 63/594,384, filed on Oct. 30, 2023.

(51) Int. Cl. B08B 3/02; B05B 9/04; B05B 12/08; B05B 15/62; B60R 9/06

(52) U.S. Cl. CPC B08B 3/028; B05B 9/0426; B05B 12/087; B05B 15/62; B60R 9/06; B08B 2203/0205; B60Y 2200/11; B60Y 2200/14; B60Y 2200/23

(57) ABSTRACT

A portable liquid-delivery system includes a portable container configured to store an internal liquid, the portable container having a peripheral wall extending along a central axis between a top wall and a bottom wall, the portable container including a cutout disposed partially inward between the peripheral wall and the central axis. A mounting module is configured to mount the portable container to a transportation device. The portable liquid-delivery system further includes a sprayer module that dispenses the internal liquid externally from the portable container.

### CROSS-REFERENCE TO RELATED APPLICATIONS

This application claims priority to and the benefit of U.S. Provisional Patent Application Ser. No. 63/594,384, filed Oct. 30, 2023, which is incorporated herein by reference in its entirety.

### FIELD OF THE INVENTION

The present invention relates generally to a liquid-delivery system, and more specifically, to a portable liquid-delivery system for cleaning portable equipment.

### BACKGROUND OF THE INVENTION

Portable equipment, for example without limitation, bicycles, lawn mowers, and other assorted outdoor equipment tend to get dirty with use. It is desirable that the portable equipment is cleaned before it is stored for the next use. However, such portable equipment is often used far from home, and far from a source of water for cleaning, for example, a home work sink or backyard garden hose. This circumstance can result in cleaning of the portable equipment being skipped or forgotten after the source of water becomes available. Aside from issues of pests or germs that can be transmitted through the dirt, if left uncleaned the portable equipment can retain moisture leading to rust, corrosion, and/or material decay. Thus a problem exists in keeping portable equipment clean when no source of water for cleaning is available.

The present disclosure provides a solution for this and other problems.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a portable liquid-delivery system comprises a portable container configured to store an internal liquid, the portable container having a peripheral wall extending along a central axis between a top wall and a bottom wall, the portable container including a cutout disposed partially inward between the peripheral wall and the central axis. A mounting module is configured to mount the portable container to a transportation device. The portable liquid-delivery system further comprises a sprayer module that dispenses the internal liquid externally from the portable container.

According to certain aspects of the present disclosure, the peripheral wall has a first thickness and the cutout has a second thickness. The second thickness is greater than the first thickness to increase structural strength of the portable container.

According to certain aspects of the present disclosure, the cutout is defined by a plurality of cutout walls. The plurality of cutout walls include two generally parallel walls coupled to each other via a connecting wall. The plurality of cutout walls have a cutout thickness that is greater than a periphery wall thickness.

According to certain aspects of the present disclosure, one or more corners of the plurality of cutout walls are rounded.

According to certain aspects of the present disclosure, the portable liquid-delivery system further comprises three feet extending from the bottom wall.

According to certain aspects of the present disclosure, the sprayer module includes a wand for spraying the internal liquid.

According to certain aspects of the present disclosure, the wand consists at least in part from a stainless steel material.

According to certain aspects of the present disclosure, the portable liquid-delivery system further comprises a clip configured to attach the wand to the portable container.

According to certain aspects of the present disclosure, the portable liquid-delivery system further comprises a pressure valve for releasing built-in pressure in the portable container.

According to certain aspects of the present disclosure, the mounting module includes a support bracket configured for mounting to a hitch extender.

According to certain aspects of the present disclosure, the support bracket is configured for mounting to a vehicle selected from a group consisting of an automobile, a golf cart, and a truck.

According to certain aspects of the present disclosure, the portable container includes at least two openings at the top wall.

According to certain aspects of the present disclosure, an opening of the at least two openings is adapted to accommodate a pump configured to pressurize an interior of the container. The pump is either a manually-actuated pump or an electrically-actuated pump.

According to certain aspects of the present disclosure, a portable liquid-delivery system comprises a portable container configured to store an internal liquid. The portable container has a peripheral wall extending along a central axis between a top wall and a bottom wall. The portable container includes a cutout having a generally U-shape. The cutout has a greater thickness than the peripheral wall. A mounting module configured to mount the portable container to a transportation vehicle. The portable liquid-delivery system further comprises a sprayer module that dispenses the internal liquid externally from the portable container.

According to certain aspects of the present disclosure, the cutout extends completely between the top wall and the bottom wall.

According to certain aspects of the present disclosure, the cutout extends partially between the top wall and the bottom wall.

According to certain aspects of the present disclosure, a portable liquid-delivery system comprises a portable container configured to store an internal liquid. The portable container has a peripheral wall extending along a central axis between a top wall and a bottom wall. The portable container includes a cutout having a greater thickness than the peripheral wall. Three feet extend from the bottom wall for supporting the portable container. The portable liquid-delivery system further comprises a sprayer module having a wand that dispenses the internal liquid externally from the portable container.

According to certain aspects of the present disclosure, the three feet are arranged symmetrically around the central axis.

According to certain aspects of the present disclosure, each foot of the three feet is in the form of a rounded bump.

According to certain aspects of the present disclosure, the portable liquid-delivery system further comprises a mounting module configured removably attaching the portable container to a transportation vehicle, the transportation vehicle including a golf cart or a landscaping vehicle.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 is a side elevational schematic view of a portable liquid-delivery system, according to some aspects of the present disclosure.

FIG. 2 is a side elevational schematic view of a portable liquid-delivery system, according to other aspects of the present disclosure.

FIG. 3 is a side elevational schematic view of a portable liquid-delivery system configured for carrying bicycles, according to some aspects of the present disclosure.

FIG. 4 is a front elevational schematic view of the portable liquid-delivery system configured for carrying bicycles, as shown in FIG. 3.

FIG. 5 is a first elevational view of a portable container for a portable liquid-delivery system, according to an aspect of the present disclosure.

FIG. 6 is a second elevational view of the portable container of FIG. 5, shown rotated 90 degrees relative to FIG. 5, according to an aspect of the present disclosure.

FIG. 7 is a third elevational view of the portable container of FIG. 5 system, shown rotated 180 degrees relative to FIG. 5 according to an aspect of the present disclosure.

FIG. 8 is a bottom view of the portable container of FIG. 5, according to an aspect of the present disclosure.

FIG. 9A is an enlarged view of the bottom of the portable container shown in FIG. 8, according to an aspect of the present disclosure.

FIG. 9B is an enlarged cross-sectional view of the portable container of FIG. 5, taken generally along the lines 9B-9B in FIG. 7, according to an aspect of the present disclosure.

FIG. 10 is an elevational view of an exemplary portable container and wand of the portable liquid-delivery system, according to an aspect of the present disclosure.

FIG. 11 is an elevational view of another exemplary portable container and wand of the portable liquid-delivery system, according to an aspect of the present disclosure.

FIG. 12 is an elevational view of a portable container for a portable liquid-delivery system, showing some exemplary dimensions, according to an aspect of the present disclosure.

FIG. 13 is a bottom view of the portable container of FIG. 12, showing some exemplary dimensions, according to an aspect of the present disclosure.

FIG. 14 is an elevational view of a portable container for a portable liquid-delivery system, showing some exemplary dimensions, according to another aspect of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

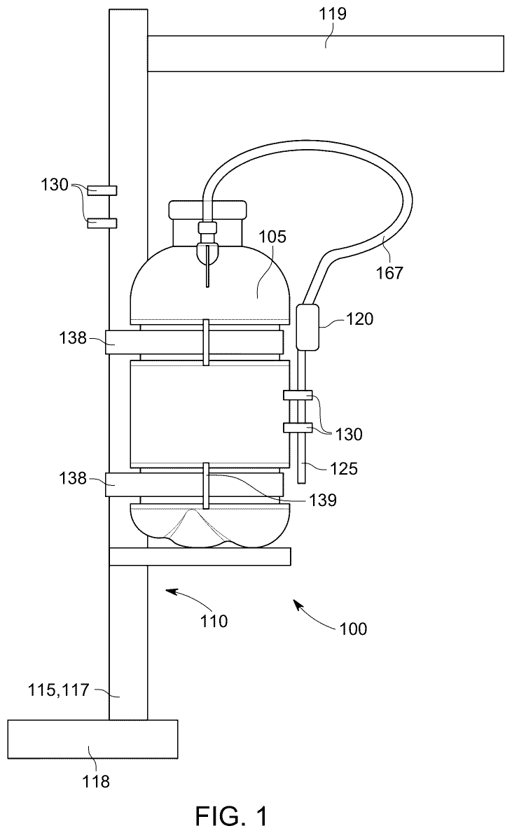

Referring to FIG. 1, a portable liquid-delivery system 100 is directed to a portable container that is mounted on a transportation device. By way of example, the portable container is mounted on a tow hitch, which, in turn, is mounted on an automobile. According to a more specific example, the tow hitch is further configured to receive for mounting thereon a bicycle. Thus, according to this example, the portable container and the bicycle are both mounted on the automobile via the tow hitch. The portable container provides a cleaning source, such as water, in a geographical location that is remote from a traditional cleaning source, such as a home sink. The transportation of the portable container is beneficial, for example, when traveling for mountain bike trips far away from home and the subsequent clean-up process after the trips are done. Although the examples above are provided for ease of understanding, it is understood that the present disclosure is not limited to these examples. As further examples, the mounted portable container is applicable to other types of tow devices and/or transportation devices.

Referring still to FIG. 1, the portable liquid-delivery system 100 includes a portable container 105 that is configured to store a liquid inside the container 105. In an embodiment a mounting module 110 is configured to mount the portable container 105 to a support bracket 115. In an embodiment the support bracket 115 is a transportation device 117, for example without limitation, such as a tow hitch for mounting one or more bicycles or any other type of hitch mounted carrying rack. For example, as illustrated in FIG. 1, the transportation device 117 includes a connector 118 for attachment to or over a vehicle trailer hitch. The exemplary transportation device 117 further includes support arms 119 (only one is visible in FIG. 1) for supporting a bicycle or other equipment.

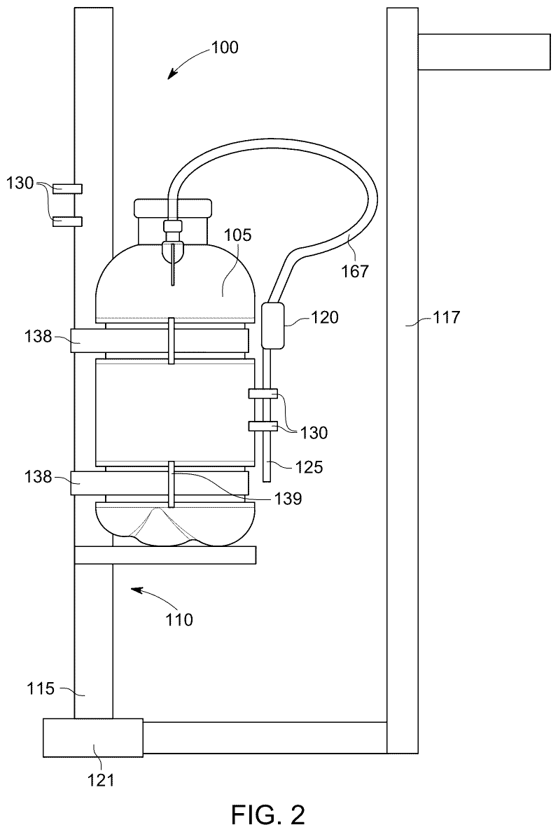

Referring to FIG. 2, in an embodiment the mounting module 110 includes the support bracket 115 coupled to or configured for mounting to a hitch extender 121, for example, configured to be disposed between a vehicle and a trailer or a transportation device 117 to couple the trailer or the transportation device 117 to the vehicle. In some embodiments the support bracket 115, the hitch extender 121, and/or the transportation device 117 are configured for mounting to a vehicle, for example without limitation, to an automobile, a golf cart, a landscaping vehicle, or a truck.

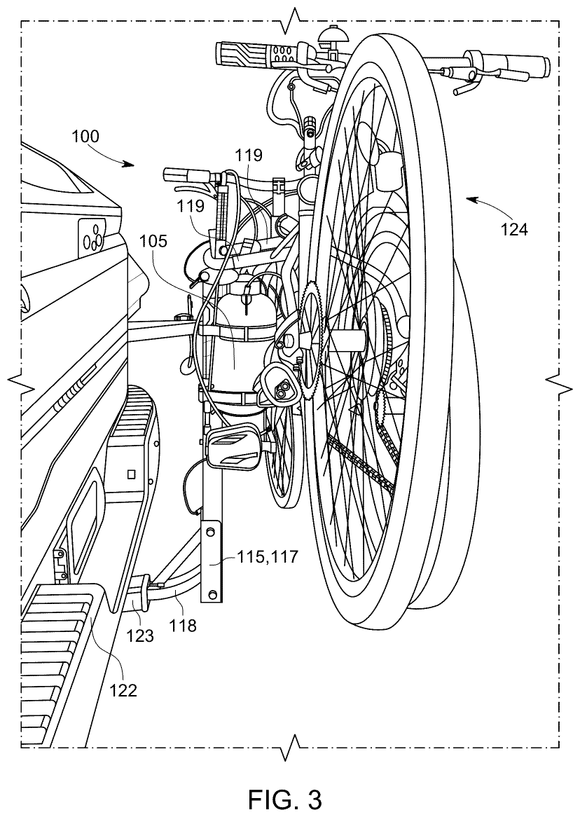

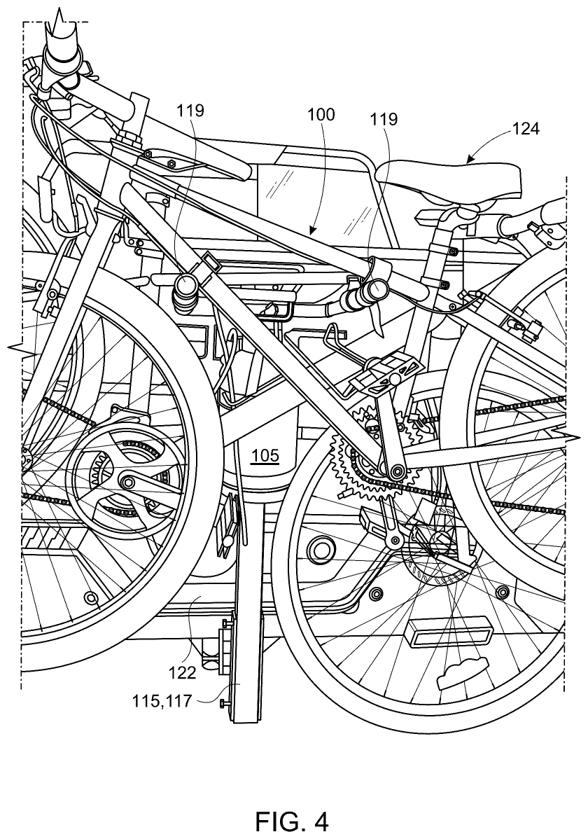

Referring generally to FIGS. 3 and 4, the portable liquid-delivery system 100 is shown in the context of a bicycle rack carrying bicycles. Referring to FIG. 3 in particular, a side view of the portable liquid-delivery system 100 is illustrated attached to a vehicle 122 having a socket style trailer hitch 123. One or more bicycles 124 are shown supported by the support arms 119 of the transportation device 117. Referring to FIG. 4 in particular, a front view of the portable liquid-delivery system 100 is illustrated attached to the vehicle 122. The bicycles 124 are clearly shown supported by two support arms 119; however, in other embodiments there can be more than two support arms 119.

Referring to FIGS. 1 and 2, in an embodiment the portable liquid-delivery system 100 further includes a sprayer module 120 that dispenses the internal liquid externally from the portable container 105. In an embodiment the sprayer module 120 includes a wand 125 for spraying the liquid from inside the portable container 105. In an embodiment the wand 125 is made at least partly from a stainless steel material. In an embodiment the portable container 105 comprises a clip 130 configured to attach the wand 125 to the portable container 105. In an embodiment the clip 130 comprises one or more sets of flexible jaws that spread apart to accommodate and hold the wand 125. In an embodiment the clip 130 is disposed on the portable container 105. In an embodiment the clip 130 is disposed on the support bracket 115 or the transportation device 117.

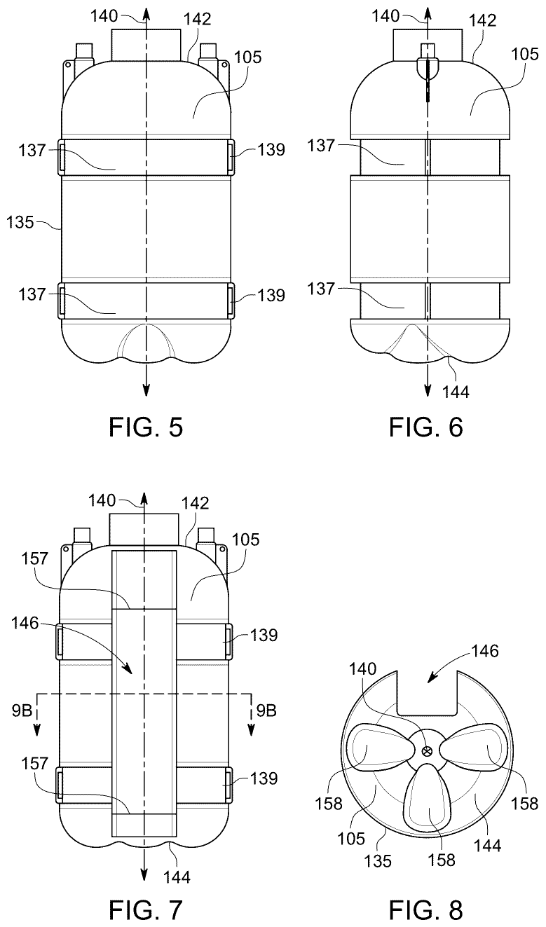

Referring generally to FIGS. 5-8, an embodiment of the portable container 105 is shown in a first elevational view in FIG. 5. The portable container 105 is shown in a second elevational view in FIG. 6, rotated 90 degrees from the view in FIG. 5. The portable container 105 is shown in a third elevational view in FIG. 7, rotated 180 degrees from the view in FIG. 5. A bottom view of the portable container 105 is shown in FIG. 8.

In an embodiment the portable container 105 has a peripheral wall 135 extending along a central axis 140 between a top wall 142 and a bottom wall 144. In an embodiment, the portable container 105 includes a cutout 146 disposed partially inward between the peripheral wall 135 and the central axis 140. In an embodiment the cutout 146 is generally U-shaped.

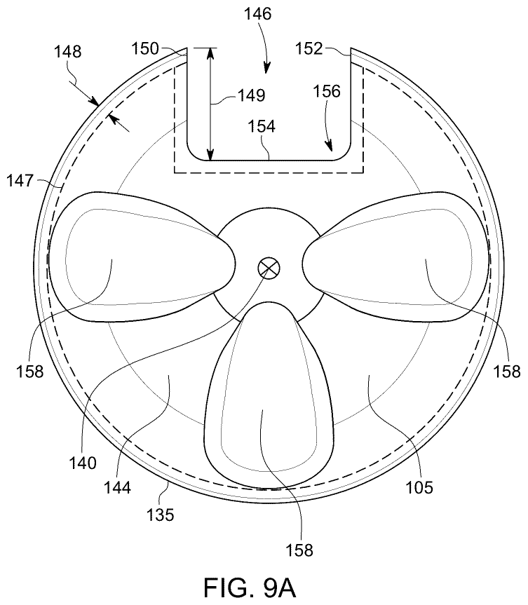

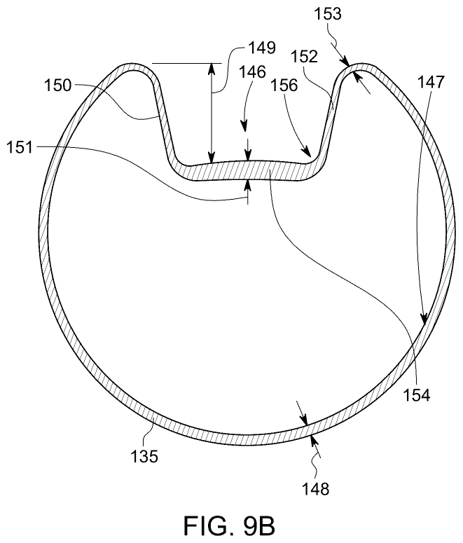

Referring initially to FIG. 9A, which is an enlarged view of FIG. 8, an internal surface 147 of the peripheral wall 135 is indicated by the dashed line 147. In an embodiment the peripheral wall 135 has a first thickness 148 around an outer diameter and the cutout 146 has a second thickness 149. In an embodiment the second thickness 149 is greater than the first thickness 148 to increase structural strength of the portable container 105.

Referring now to both FIGS. 9A and 9B, in an embodiment the cutout 146 is defined by a portion of the peripheral wall 135 that includes a plurality of walls that include two generally parallel walls 150 and 152 coupled to each other via a connecting wall 154. In an embodiment the plurality of cutout walls 150, 152, 154 form the cutout 146 having the second thickness 149 that is greater than the first thickness 148 of the peripheral wall 135. In an embodiment, one or more corners of the plurality of cutout walls 150, 152, 154 are rounded, for example, as indicated at rounded corner 156.

Referring more specifically to FIG. 9B, in an embodiment the peripheral wall 135 has more than one thickness. For example, in addition to the first thickness 148 around the outer diameter, the connecting wall 154 of the peripheral wall 135 has a thicker portion 151. In addition, the peripheral wall 135 has a thinner portion 153 near the outer corners of the cutout 146. In an embodiment, a ratio of the thickness of the thicker portion 151 to the thickness of the thinner portion 153 is at least about 3 to 1. For example, the first thickness 148 is about 2 millimeters (mm) thick, the thinner portion 153 is about 1.5 mm or less, and the thicker portion 151 is about 4.5 mm or more. In other embodiments the thickness ratio can be other than 3 to 1 and the actual wall thicknesses can be other than the thicknesses indicated here.

In an embodiment the portable container 105 comprises a plurality of feet 158 extending from the bottom wall 144. In an embodiment the portable container 105 comprises three feet 158 extending from the bottom wall 144. In an embodiment the three feet 158 are arranged symmetrically around the central axis 140. In an embodiment each of the three feet 158 is in the form of a rounded bump 158.

Referring to FIG. 7, in an embodiment the cutout 146 extends completely between the top wall 142 and the bottom wall 144. In an embodiment the cutout 146 extends at least partially between the top wall 142 and the bottom wall 144, for example, bounded at top and bottom ends as shown by lines 157.

Referring again to FIGS. 5-8, in an embodiment the portable container 105 includes one or more circumferential recesses 137. Each of the circumferential recesses 137 is sized to accommodate a strap 138 (see FIGS. 1 and 2) for helping to secure the portable container 105 to the support bracket 115. In an embodiment, each of the circumferential recesses 137 includes a strap loop 139 for guiding and holding the straps 138 on the portable container 105.

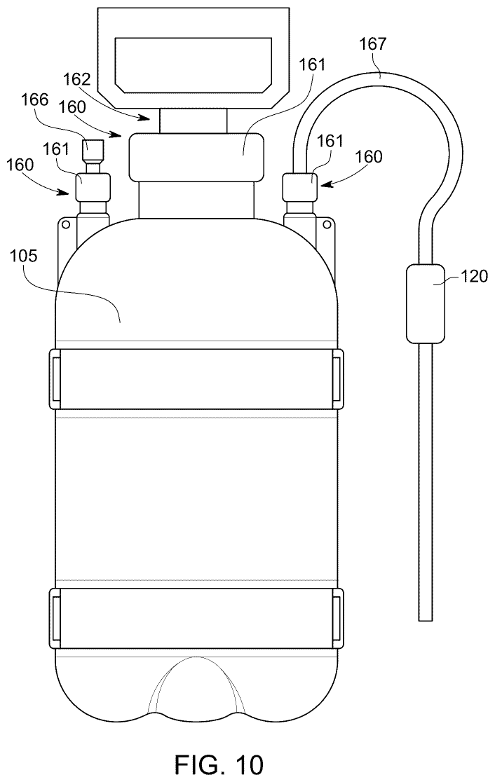

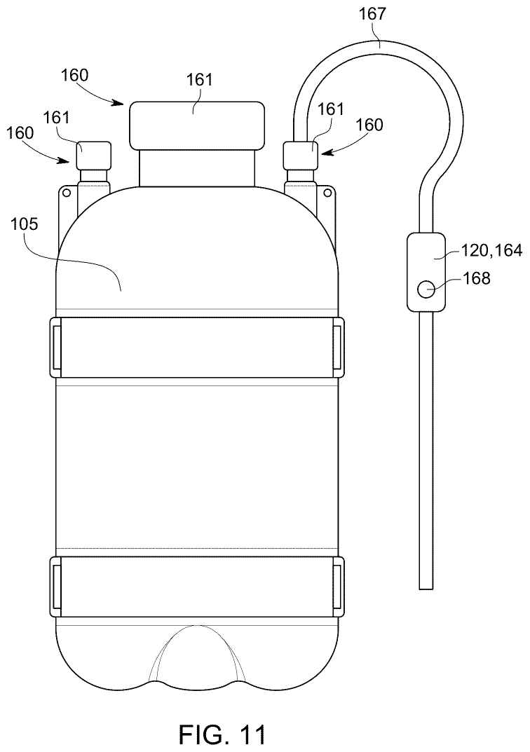

Referring to FIGS. 10 and 11, in an embodiment the portable container 105 includes at least two openings 160 disposed through the top wall 142. In an embodiment the portable container 105 includes three openings 160 disposed through the top wall. In an embodiment each of the openings 160 has a cap or fitting 161 that seals the opening 160 or that provides a sealed passage for another component through the opening 160. In an embodiment the cap or fitting 161 threadably attaches over the opening. In other embodiments the cap or fitting 161 attaches over the opening 160 via a press fit or another detachable mechanism for attachment.

In an embodiment an opening 160 of the at least two openings 160 is adapted to accommodate a pump 162, 164 configured to pressurize an interior of the container 105. In an embodiment an opening 160 of the at least two openings 160 is adapted to accommodate a hose 167 attached to the sprayer module 120. In an embodiment an opening 160 of the at least two openings 160 is adapted to accommodate a pressure valve 166 for releasing built-up pressure in the portable container 105. In an embodiment the pump 162, 164 is a manually-actuated pump 162 (see FIG. 10). In another embodiment the pump 162, 164 is an electrically-actuated pump 164. In an embodiment having the electrically-actuated pump 164, the pump is part of the sprayer module 120. In an embodiment, the electrically-actuated pump 164 is actuated via a button or switch 168 on the sprayer module 120. In an embodiment the portable container 105 further comprises the pressure valve 166 for releasing built-up pressure in the portable container 105.

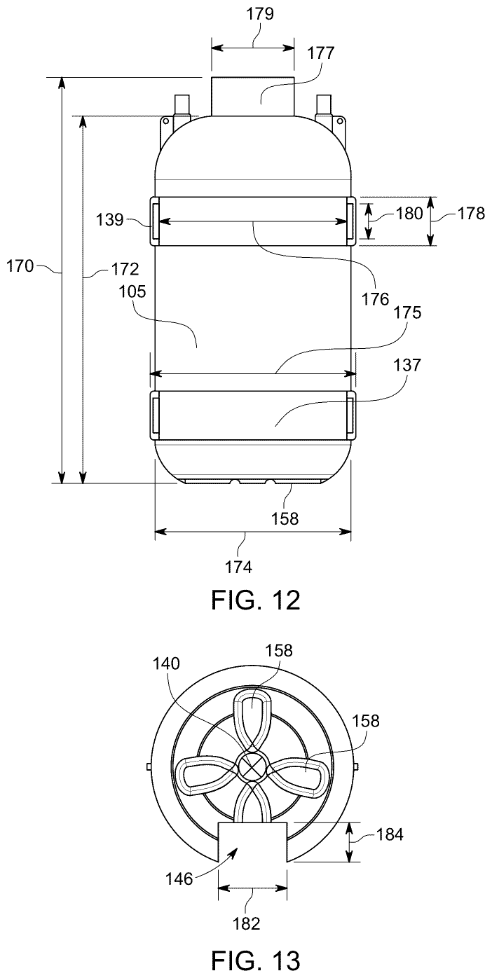

Referring now to FIG. 12, an embodiment of a portable container 105 is illustrated showing some exemplary dimensions. For example, a total height 170 is about 315 mm and a height 172 without the opening portion 177 is about 284 mm. A diameter 174 of the portable container 105 is about 160 mm. A diameter 176 measured within a circumferential recess 137 is about 148 mm. The strap loops 139 have an outer width 178 of about 36 mm and an inner width 180 of about 26 mm. A diameter 175 of the portable container 105 measured including the strap loops 139 is about 161.5 mm. The diameter 179 of the outside of the opening portion 177 is about 67 mm.

Referring to FIG. 13, a bottom of the portable container 105 of FIG. 12 is shown. In this embodiment, the portable container 105 comprises four feet 158 extending from the bottom wall 144 (FIGS. 6-8). In an embodiment the four feet 158 are arranged symmetrically around the central axis 140. In an embodiment each of the four feet 158 is in the form of a rounded bump 158. In an embodiment, the cutout 146 has a width 182 of about 62 mm and a depth 184 of about 37 mm.

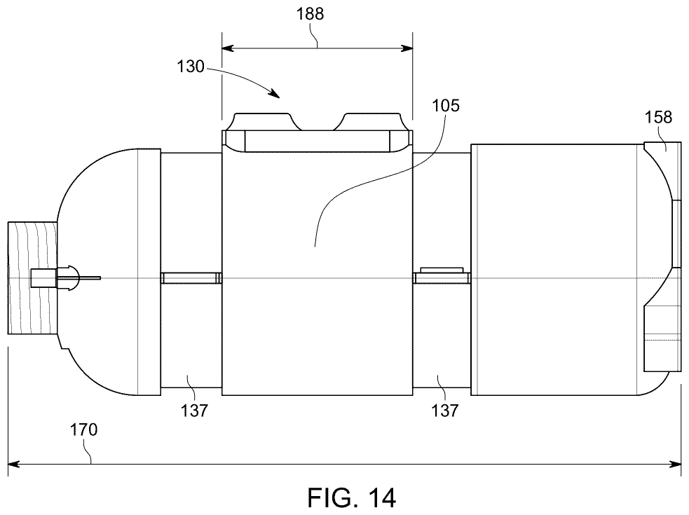

Referring to FIG. 14, in another embodiment, the portable container 105 can have the same diameter but can be longer or taller so that the total height 170 is greater than about 315 mm. In either of the embodiments illustrated in FIG. 13 or 14, the portable container 105 can also include the clip 130. In either of the embodiments illustrated in FIG. 13 or 14, the portable container 105 can have three or four feet 158. A base of the clip 130 is illustrated to have a height 188 of about 100 mm. In an embodiment, the dimensions and ratio of wall thicknesses provided above apply to both of the sizes of the portable container 105 as shown in FIGS. 13 and 14.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A portable liquid-delivery system comprising:
a portable container configured to store an internal liquid, the portable container having a peripheral wall extending along a central axis between a top wall and a bottom wall, the portable container including a cutout disposed partially inward between the peripheral wall and the central axis;
a mounting module configured to mount the portable container to a transportation device; and
a sprayer module that dispenses the internal liquid externally from the portable container.

2. The portable liquid-delivery system of claim 1, wherein the peripheral wall has a first thickness and the cutout has a second thickness, the second thickness being greater than the first thickness to increase structural strength of the portable container.

3. The portable liquid-delivery system of claim 1, wherein the cutout is defined by a plurality of cutout walls, the plurality of cutout walls including two generally parallel walls coupled to each other via a connecting wall, the plurality of cutout walls having a cutout thickness that is greater than a periphery wall thickness.

4. The portable liquid-delivery system of claim 3, wherein one or more corners of the plurality of cutout walls are rounded.

5. The portable liquid-delivery system of claim 1, further comprising three feet extending from the bottom wall.

6. The portable liquid-delivery system of claim 1, wherein the sprayer module includes a wand for spraying the internal liquid.

7. The portable liquid-delivery system of claim 6, wherein the wand consists at least in part from a stainless steel material.

8. The portable liquid-delivery system of claim 6, further comprising a clip configured to attach the wand to the portable container.

9. The portable liquid-delivery system of claim 1, further comprising a pressure valve for releasing built-in pressure in the portable container.

10. The portable liquid-delivery system of claim 1, wherein the mounting module includes a support bracket configured for mounting to a hitch extender.

11. The portable liquid-delivery system of claim 10, wherein the support bracket is configured for mounting to a vehicle selected from a group consisting of an automobile, a golf cart, and a truck.

12. The portable liquid-delivery system of claim 1, wherein the portable container includes at least two openings at the top wall.

13. The portable liquid-delivery system of claim 12, wherein one opening of the at least two openings is adapted to accommodate a pump configured to pressurize an interior of the container, the pump being either a manually-actuated pump or an electrically-actuated pump.

14. A portable liquid-delivery system comprising:
a portable container configured to store an internal liquid, the portable container having a peripheral wall extending along a central axis between a top wall and a bottom wall, the portable container including a cutout having a generally U-shape, the cutout having a greater thickness than the peripheral wall;
a mounting module configured to mount the portable container to a transportation vehicle; and
a sprayer module that dispenses the internal liquid externally from the portable container.

15. The portable liquid-delivery system of claim 14, wherein the cutout extends completely between the top wall and the bottom wall.

16. The portable liquid-delivery system of claim 14, wherein the cutout extends partially between the top wall and the bottom wall.

17. A portable liquid-delivery system comprising:
a portable container configured to store an internal liquid, the portable container having a peripheral wall extending along a central axis between a top wall and a bottom wall, the portable container including a cutout having a greater thickness than the peripheral wall;
three feet extending from the bottom wall for supporting the portable container; and
a sprayer module having a wand that dispenses the internal liquid externally from the portable container.

18. The portable liquid-delivery system of claim 17, wherein the three feet are arranged symmetrically around the central axis.

19. The portable liquid-delivery system of claim 17, wherein each foot of the three feet is in the form of a rounded bump.

20. The portable liquid-delivery system of claim 17, further comprising a mounting module configured removably attaching the portable container to a transportation vehicle, the transportation vehicle including a golf cart or a landscaping vehicle.
